(19) United States
(12) Patent Application Publication
(10) Pub. No.: US 2013/0180368 A1
(43) Pub. Date: Jul. 18, 2013

(54) FALLING PREVENTION STRUCTURE FOR SOCKET IN ELECTRIC POWER TOOL

(71) Applicants: Ryunosuke KUMAGAI, Anjo-shi (JP); Tokuo HIRABAYASHI, Anjo-shi (JP); Takao KUROYANAGI, Anjo-shi (JP); Manabu SUGIMOTO, Anjo-shi (JP)

(72) Inventors: Ryunosuke KUMAGAI, Anjo-shi (JP); Tokuo HIRABAYASHI, Anjo-shi (JP); Takao KUROYANAGI, Anjo-shi (JP); Manabu SUGIMOTO, Anjo-shi (JP)

(21) Appl. No.: 13/693,621

(22) Filed: Dec. 4, 2012

(30) Foreign Application Priority Data
Jan. 16, 2012 (JP) 2012-006349

(51) Int. Cl. B25D 17/08

(52) U.S. Cl. CPC B25D 17/08
USPC 81/185.2

(57) ABSTRACT

In an impact driver, a supporting ring, to which a carabiner and so on of a socket is connected, is provided in a shaft support portion in a front end of a hammer case so that the supporting ring is able to be attached and detached by using a screw. Further, a falling prevention element (wire) is provided in the supporting ring. The falling prevention element comes to a position adjacent to the screw which clamps the supporting ring so that the supporting ring is prevented from falling from the impact driver.

### BACKGROUND OF THE INVENTION

This application claims the benefit of Japanese Patent Application Number 2012-006349 filed on Jan. 16, 2012, the entirety of which is incorporated by reference.

### TECHNICAL FIELD

The present invention relates to a structure in an electric power tool such as an impact driver, the structure preventing falling of a socket that is mounted on an output shaft.

### BACKGROUND ART

In an electric power tool such as an impact driver, a socket is used as a distal end tool when a bolt or a nut is fastened. The socket is mounted on an output shaft through a bit adapter or the like attached to the output shaft that projects frontward from a housing, or the socket is attached to the output shaft by directly mounting a bit portion, which is provided integrally in the socket, onto the output shaft. In such cases, in order to prevent the socket from falling from the electric power tool when the socket comes off or the bit or the bit portion is broken off, the present applicants have provided, for example, a falling prevention structure described in International Publication No. WO2011/111465. The configuration of the falling prevention structure is that, in an electric power tool, a connecting body such as a carabiner which connects the electric power tool and a socket is connected to a supporting member such as a supporting ring, and the supporting member is provided so as to be attached to and detached from the electric power tool using a screw member such as a bolt.

However, in the above-described falling prevention structure, when the screw member comes off, the supporting member falls from the electric power tool and it thus may become impossible to prevent the socket from falling.

### SUMMARY OF THE INVENTION

An object of the present invention is to provide a highly reliable falling prevention structure for a socket in an electric power tool, the falling prevention structure being able to prevent a supporting member from falling when a screw member comes off.

In order to achieve the above object, a falling prevention structure for a socket in an electric power tool according to a first aspect of the present invention includes a connecting body which connects the electric power tool and the socket to each other, the electric power tool having an output shaft projecting to a front of a housing and the socket being mounted on the output shaft in an attachable and detachable manner, a supporting member which is provided in the electric power tool so that the supporting member is able to be attached and detached by using a screw member, and to which the connecting body is connected, and a falling prevention element which is provided in the supporting member and prevents the supporting member from falling from the electric power tool.

According to a second aspect of the present invention, in the falling prevention structure for a socket in an electric power tool according to the first aspect, the falling prevention element is a screw falling prevention member which prevents the screw member from falling from the supporting member.

According to a third aspect of the present invention, in the falling prevention structure for a socket in an electric power tool according to the second aspect, the screw falling prevention member is a wire which abuts on or is located adjacent to a head portion of the screw member.

According to a fourth aspect of the present invention, in the falling prevention structure for a socket in an electric power tool according to the third aspect, the wire has a rectangular loop shape.

According to a fifth aspect of the present invention, in the falling prevention structure for a socket in an electric power tool according to the first aspect, a cover is mounted on the housing of the electric power tool, an attaching groove is provided along a circumference of a front end of the housing so that the cover is engaged with the attaching groove and is thus retained, and the supporting member is mounted on the front end of the housing while being engaged with the attaching groove.

With the falling prevention structure for a socket in an electric power tool according to the first aspect, since the falling prevention element is adopted, the supporting member is prevented from falling when the screw member comes off. Therefore, reliability of socket falling prevention is enhanced.

With the falling prevention structure for a socket in an electric power tool according to the second aspect, in addition to the effect of the first aspect, the supporting member is prevented from falling in a favorable manner by preventing the screw member from falling.

With the falling prevention structure for a socket in an electric power tool according to the third and fourth aspects, in addition to the above effects, the screw falling prevention member is formed with ease.

With the falling prevention structure for a socket in an electric power tool according to the fifth aspect, in addition to the effect of the first aspect, it is possible to ensure that supporting member is retained by using the existing attaching groove.

### BRIEF DESCRIPTION OF THE DRAWINGS

FIG. 1 is a left side view of an impact driver.

FIG. 2 is a front view of the impact driver.

FIG. 3 is a right side view of the impact driver.

FIG. 4 is a bottom view of a distal end portion.

FIG. 5 is a sectional view taken along a line A-A in FIG. 1.

FIG. 6 is a sectional view taken along a line B-B in FIG. 1.

FIG. 7 is a sectional view taken along a line C-C in FIG. 2.

### DETAILED DESCRIPTION OF THE EMBODIMENTS

An embodiment of the present invention will be described below based on the drawings.

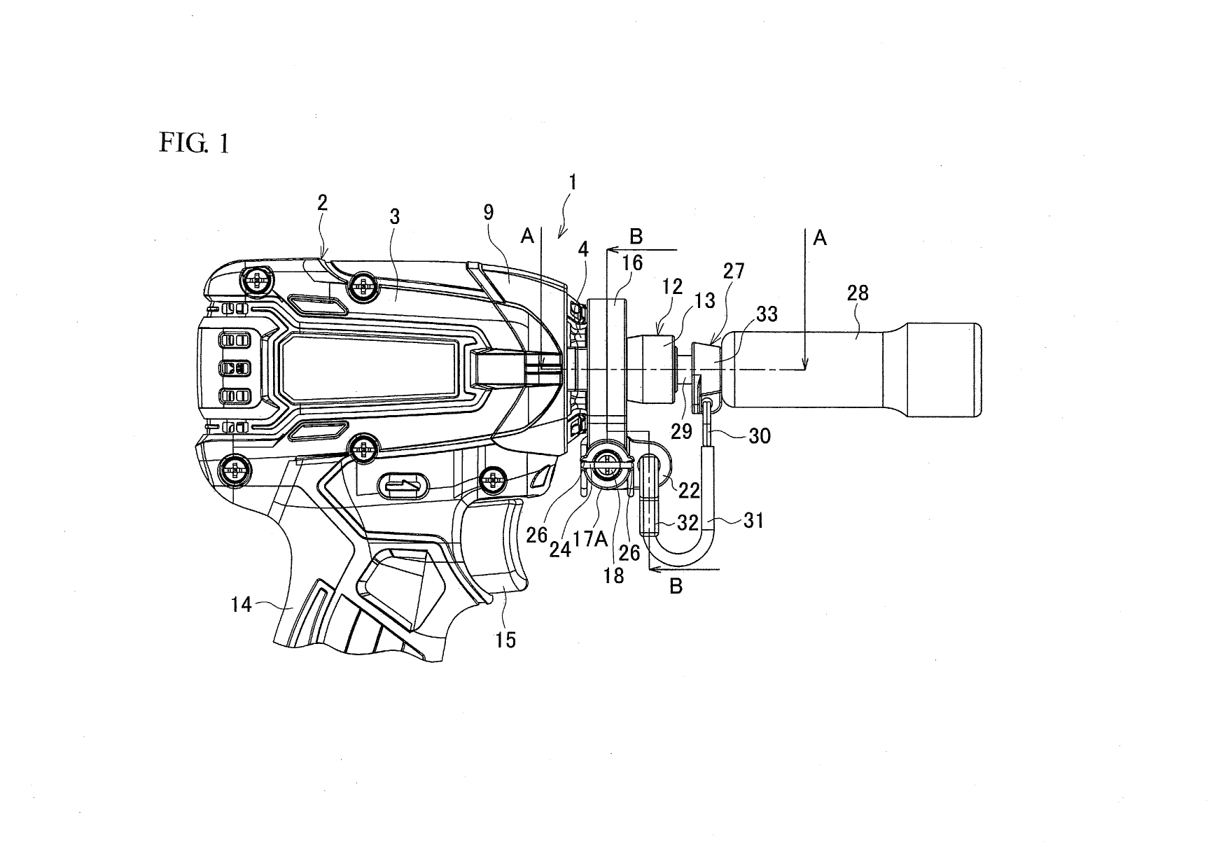

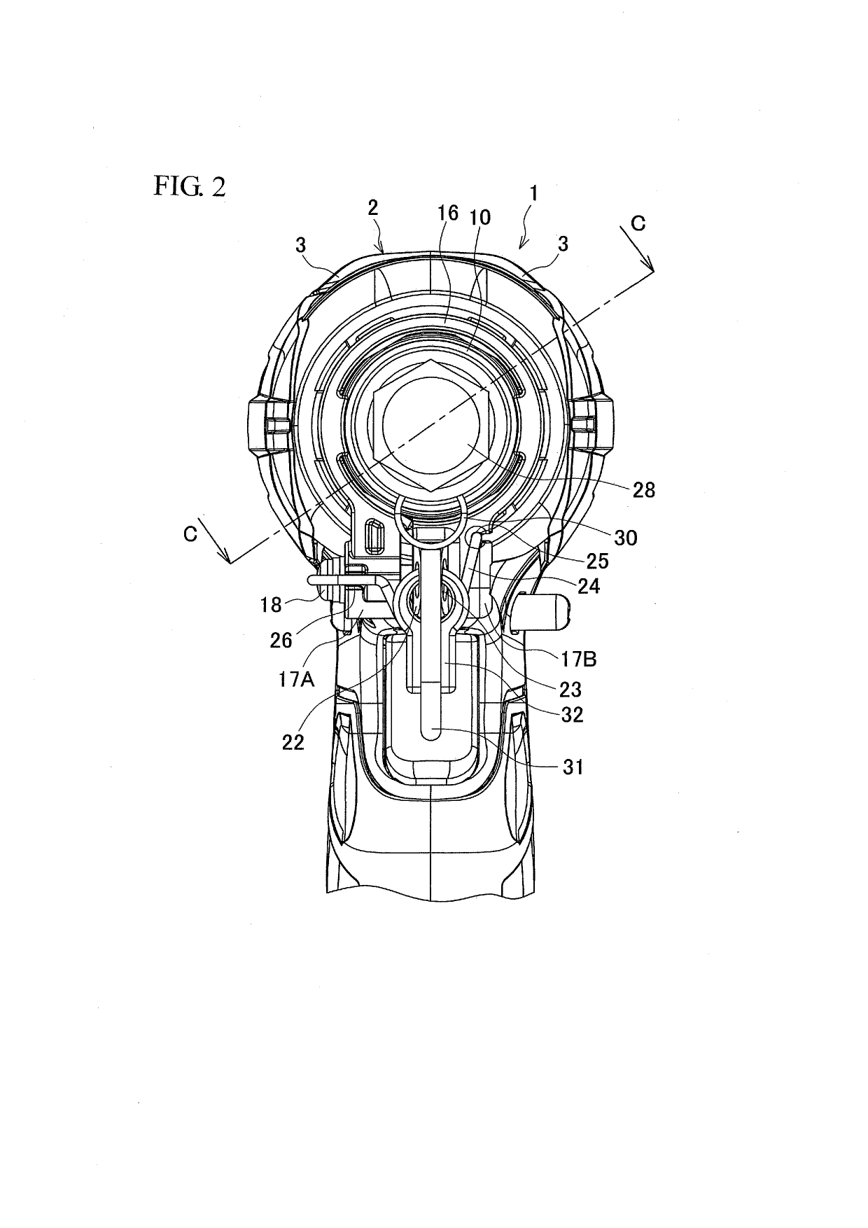

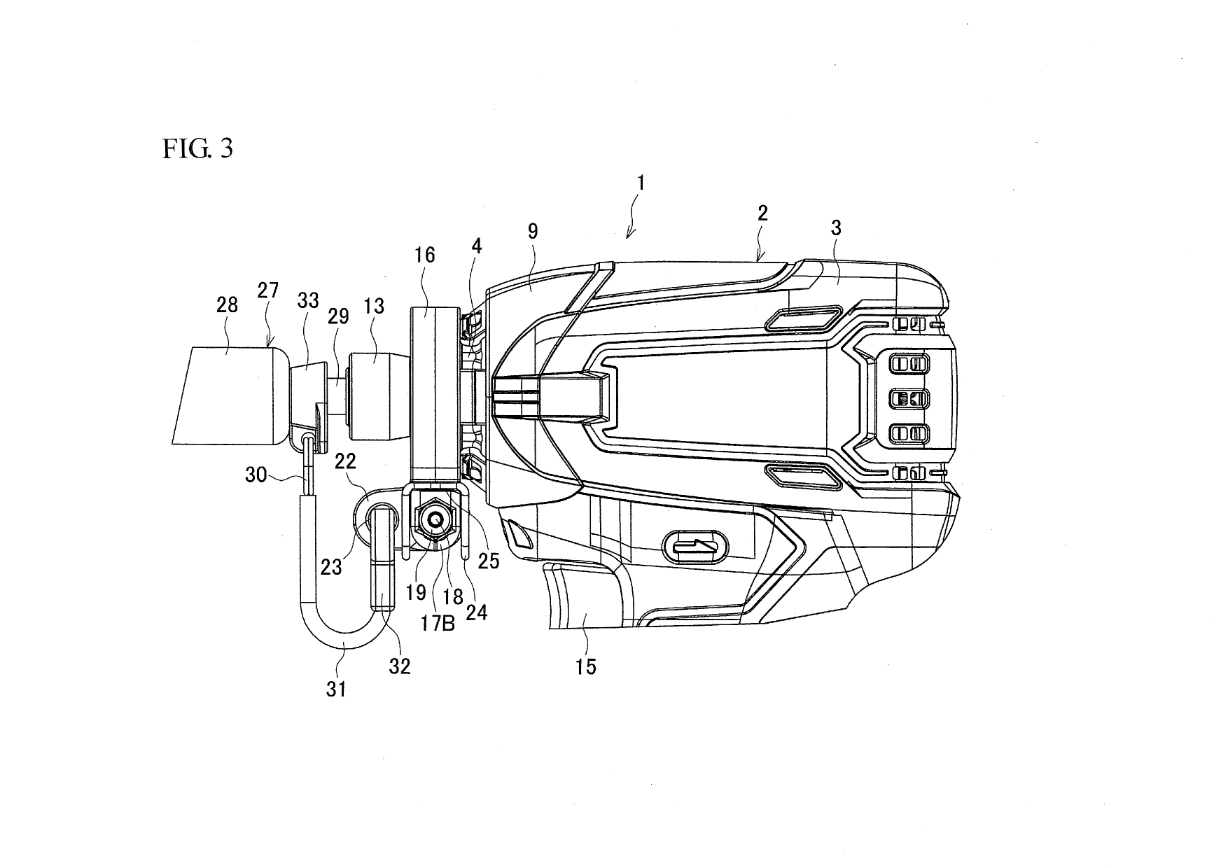

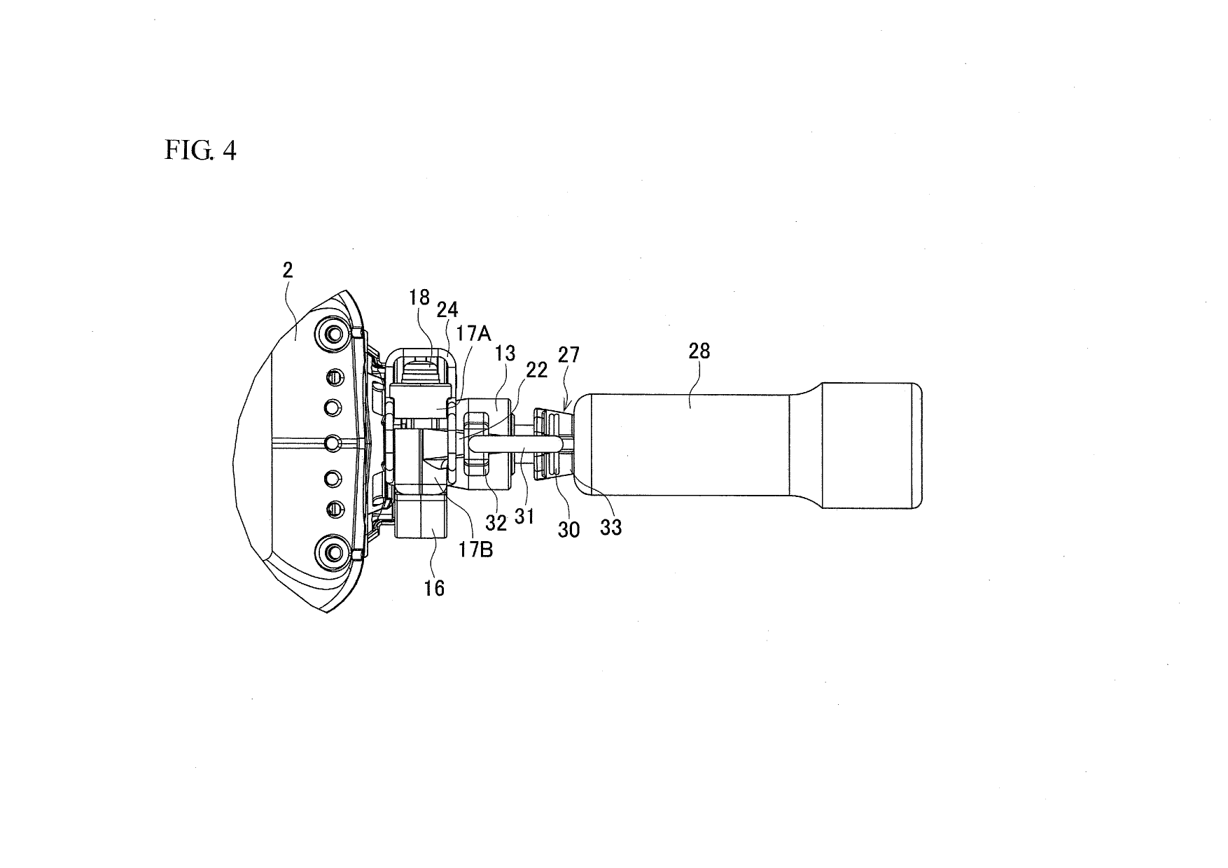

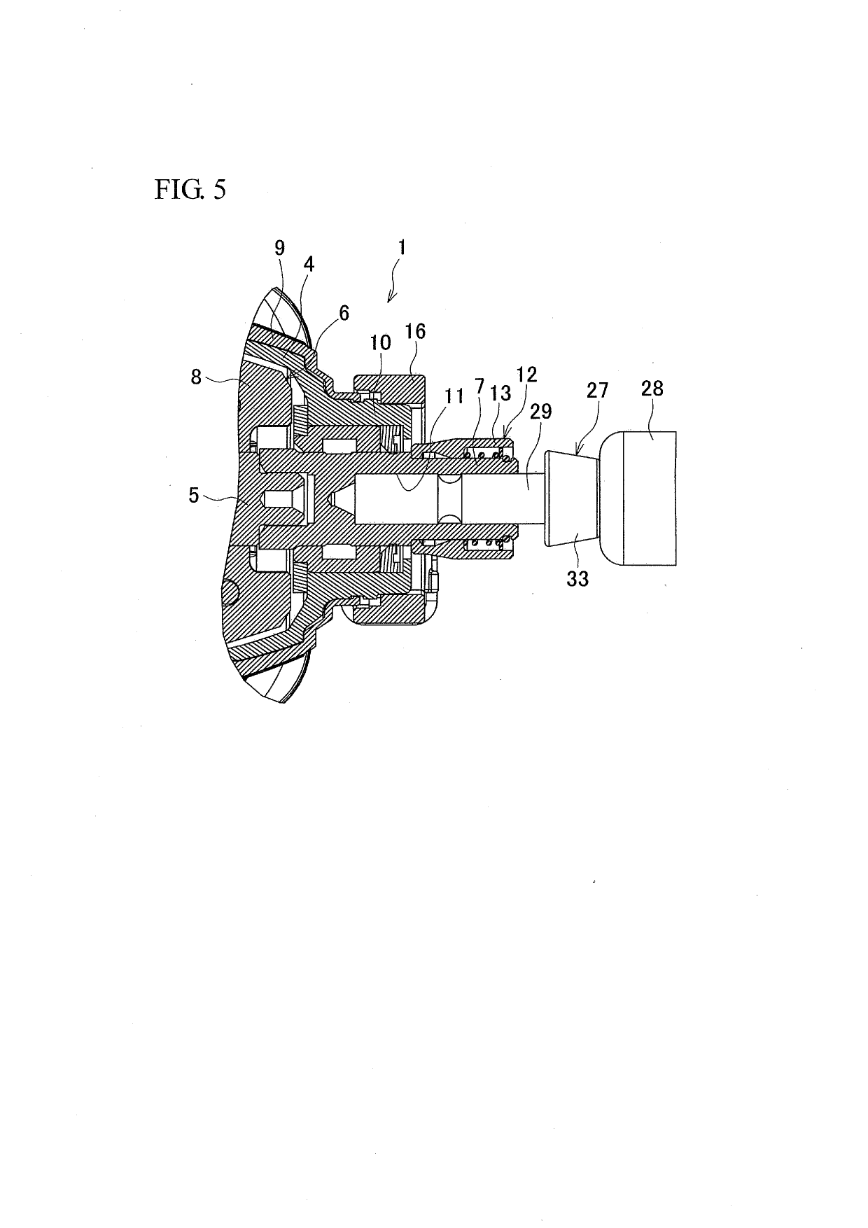

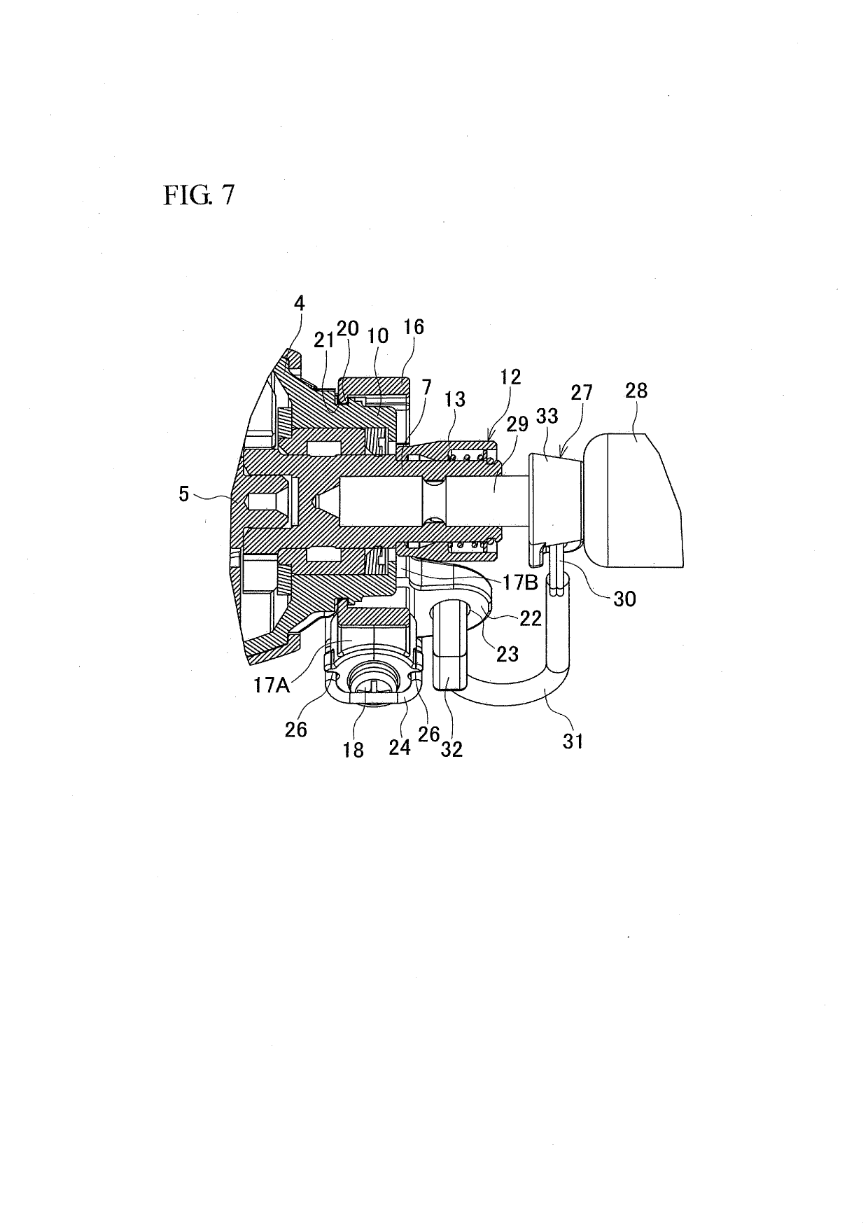

FIG. 1 to FIG. 7 show an example of a falling prevention structure for a socket. A reference numeral 1 denotes an impact driver serving as an electric power tool. The impact driver 1 includes a body housing 2 and a hammer case 4. The body housing 2 is made of synthetic resin and is formed by assembling right and left half housings 3 and 3 to one another so as to accommodate a motor. The hammer case 4 made of metal is assembled to a front side (right side in FIG. 1) of the body housing 2, and serves as a front-side housing accommodating a spindle 5, an impact mechanism 6, and an anvil 7 serving as an output shaft. The impact mechanism 6 has a conventional configuration in which a hammer 8 is repeatedly engaged with and disengaged from the anvil 7 with an increase in torque of the anvil 7, thereby generating an impact in a rotation direction.

The hammer case 4 is a cylindrical body in which a rear part thereof is inserted in the body housing 2 and screwed into a gear housing inside the body housing 2. A front part of the hammer case 4, which is exposed from the body housing 2, has a tapered shape towards a front end and is covered by a cover 9 made of synthetic resin. The anvil 7 is rotatably supported by a shaft support portion 10 formed in a front end of the hammer case 4, and the anvil 7 projects frontward. In a front end of the anvil 7, a mounting hole 11 for a bit is formed, and a chuck mechanism 12 having a ball (not shown) and a sleeve 13 is also provided to retain the bit inserted in the mounting hole 11.

Meanwhile, a handle 14 extends downward from a bottom of the body housing 2. A battery pack (not shown) serving as a power source is attached to a bottom end of the handle 14. A reference numeral 15 denotes a trigger.

A supporting ring 16 functioning as a supporting member is mounted on the shaft support portion 10 of the hammer case 4. The supporting ring 16 has a ring shape in which a lower portion thereof is split up with a given space therebetween, forming a pair of clamp pieces 17A and 17B. A screw 18 serving as a screw member that passes through the one clamp piece 17A from outside is screwed to a nut 19 that is fitted in the other clamp piece 17B. In a rear end of an inner circumference of the supporting ring 16, a ridge 20 is provided so as to extend in a circumferential direction. In an outer circumference of the shaft support portion 10, an attaching groove 21 is provided along the circumference so that the ridge 20 is fitted to the attaching groove 21 at a mounting position of the supporting ring 16. The attaching groove 21 allows a distal end of the cover 9 to be engaged therewith so that the cover 9 is retained. Although a ring-shaped rubber bumper serving as a buffer member is fitted to the distal end of the cover 9, the bumper is removed when the supporting ring 16 is mounted on the shaft support portion 10.

Therefore, as the space between the clamp pieces 17A and 17B is decreased by tightening the screw 18, an inner diameter of the supporting ring 16 is reduced, thereby clamping the shaft support portion 10. On the contrary, as the space between the clamp pieces 17A and 17B is increased by loosening the screw 18, the inner diameter of the supporting ring 16 is increased, thereby unclamping the shaft support portion 10.

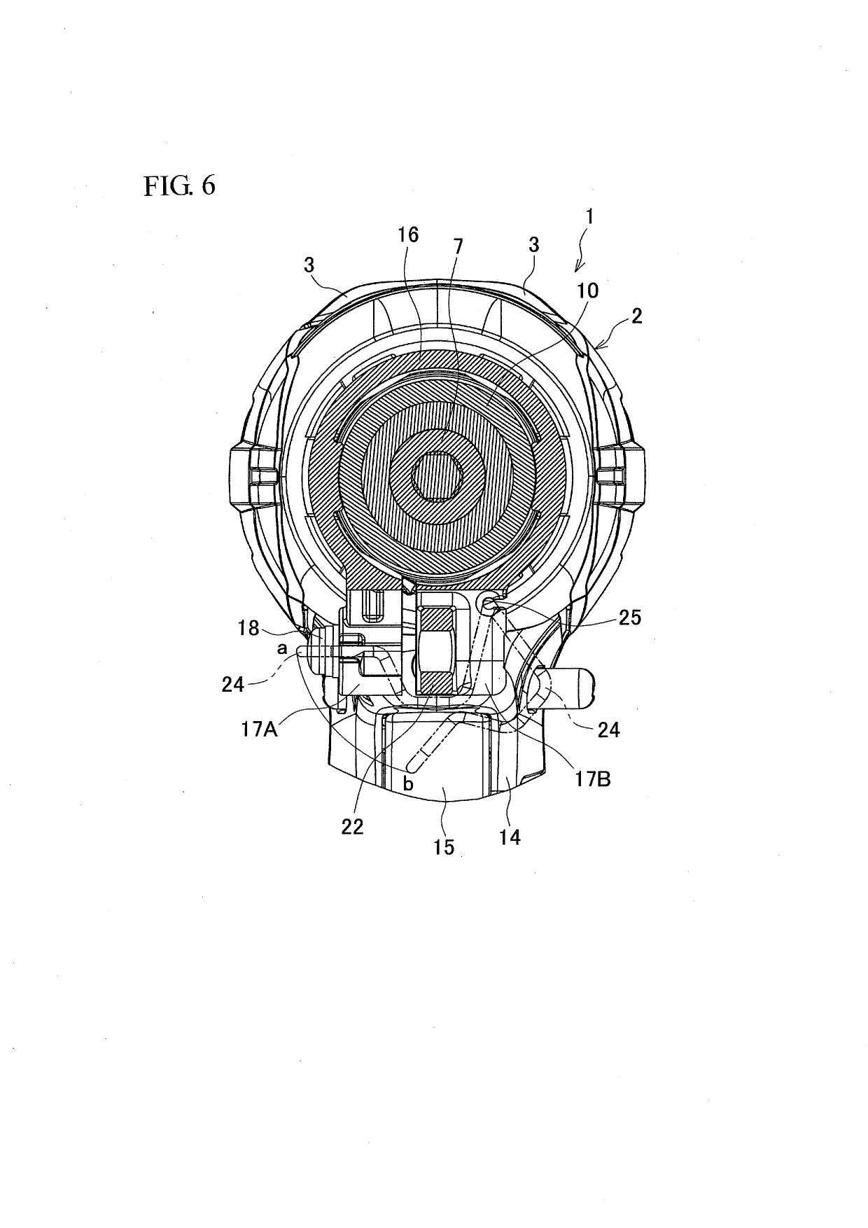

On a front surface of the other clamp piece 17B, a protrusion 22 having a through hole 23 perforated therethrough projects frontward for connecting the socket. On the other hand, a wire 24 serving as a screw falling prevention member is connected to an outer surface of the clamp piece 17B. The wire 24 has a rectangular loop shape, and one side of the wire 24 is fitted into a fitting recess 25 formed in a base of the clamp piece 17B on an outer side thereof, and is rotatably supported. An intermediate portion of the wire 24 is bent such that the other side of the wire 24 facing the one side thereof detours around the bottom of the protrusion 22 and reaches an outer side of the clamp piece 17A. In both front and rear surfaces of the clamp piece 17A, engageable recessed portions 26 and 26 are formed, respectively, so that the other side of the wire 24 is elastically engaged with the engageable recessed portions 26 and 26. In a state where the wire 24 is engaged with the engageable recessed portions 26 and 26, the other side of the wire 24 is located at an adjacent position (a chain double-dashed line a shown in FIG. 6) that passes across an outer side of a head portion of the screw 18 without contacting the head portion of the screw 18. When the wire 24 is separated from the engageable recessed portions 26 and 26, the wire 24 is able to rotate to move to a remote position (a chain double-dashed line b shown in FIG. 6) away from the outer side of the screw 18.

The reference numeral 27 denotes a socket that is mounted on the anvil 7, and includes a socket portion 28 to which a bolt or a nut is able to be fitted, and a bit portion 29 having the same figure as to the bit. A string-like body 31 is connected to a rear part of the socket portion 28 through a ring 30, and a carabiner 32 is connected to a distal end of the string-like body 31. The carabiner 32 is passed through the through hole 23 of the protrusion 22, thereby connecting the socket portion 28 and the protrusion 22. The ring 30, the string-like body 31, and the carabiner 32 form a connecting body. An intermediate ring 33 to which the ring 30 is connected is separated from the socket portion 28 and the bit portion 29 in a rotation direction. Hence, the intermediate ring 33 does not rotate along with rotation of the socket portion 28 or the bit portion 29.

In the impact driver 1 having the configuration described so far, the screw 18 is tightened while the wire 24 is at the remote position and the supporting ring 16 is at the mounting position. In the mounting position, the supporting ring 16 is mounted on the outer side of the shaft support portion 10 and the ridge 20 is fitted into the attaching groove 21. As the screw 18 is tightened, the inner diameter of the supporting ring 16 is reduced as stated earlier, and consequently, the supporting ring 16 is clamped to the shaft support portion 10 while being retained because the ridge 20 is fitted into the attaching groove 21. Thereafter, once the wire 24 is rotated to the adjacent position and the other side of the wire 24 is engaged with the engageable recessed portions 26 and 26, the other side of the wire 24 prevents the screw 18 from falling. That is, even when the screw 18 loosens, the screw 18 comes into contact with the other side of the wire 24 and is not allowed to loosen farther, which prevents the screw 18 from falling from the clamp pieces 17A and 17B. Here, the screw 18 is kept screwed in the nut 19 at the position where the screw 18 is in contact with the other side of the wire 24.

By inserting the bit portion 29 of the socket 27 into the mounting hole 11 of the anvil 7, the socket 27 is retained by the chuck mechanism 12 similarly to a regular bit. In this state, once the carabiner 32 of the socket 27 is connected to the protrusion 22, the socket portion 28 is connected to the supporting ring 16 through the ring 30, the string-like body 31, and the carabiner 32.

Therefore, even if the bit portion 29 is broken off while the socket 27 is used to fasten a bolt or a nut, the socket portion 28 hangs from the supporting ring 16 through the carabiner 32, and is thereby prevented from falling from the impact driver 1.

According to the falling prevention structure for the socket 27 in the foregoing embodiment, the impact driver 1 is provided with the supporting ring 16 to which the carabiner 32 and so on are connected, and the supporting ring 16 is able to be attached to and detached from the impact driver 1 by using the screw 18. At the same time, the supporting ring 16 includes a falling prevention element (wire 24) which prevents the supporting ring 16 from falling from the impact driver 1, thus preventing the supporting ring 16 from falling when the screw 18 comes off. Therefore, reliability of falling prevention for the socket 27 is enhanced.

In particular, since the falling prevention element is a screw falling prevention member (wire 24) which prevents the screw 18 from falling from the supporting ring 16, the supporting ring 16 is prevented from falling in a favorable fashion by preventing falling of the screw 18.

Further, since the screw falling prevention member is the wire 24 adjacent to the head portion of the screw 18, the screw falling prevention member is formed with ease.

In a state where the bumper is removed, the supporting ring 16 is mounted on the front end of the hammer case 4 while being engaged with the attaching groove 21. Therefore, it is possible to ensure that the supporting ring 16 is retained by using the existing attaching groove 21.

In the embodiment described above, the wire is located adjacent to the head portion of the screw. However, the wire may abut on the head portion of the screw in order to prevent the screw from falling. Further, the connecting body may not include the ring or the string-like body, or conversely may be formed only of a plurality of rings or the string-like body.

The screw member may be a bolt. The shape of the wire is not limited to the loop shape, and may be a shape in which a distal end portion of the wire is bent into an L shape or the like and located adjacent to or abutted on the screw member.

The present invention is applicable to other types of electric power tools such as an electric power tool adopting an oil unit as an impact mechanism.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A falling prevention structure for a socket in an electric power tool, the falling prevention structure comprising:
a connecting body which connects the electric power tool and the socket to each other, the electric power tool having an output shaft projecting to a front of a housing and the socket being mounted on the output shaft in an attachable and detachable manner;
a supporting member which is provided in the electric power tool so that the supporting member is able to be attached and detached by using a screw member, and to which the connecting body is connected; and
a falling prevention element which is provided in the supporting member and prevents the supporting member from falling from the electric power tool.

2. The falling prevention structure for a socket in an electric power tool according to claim 1, wherein the falling prevention element is a screw falling prevention member which prevents the screw member from falling from the supporting member.

3. The falling prevention structure for a socket in an electric power tool according to claim 2, wherein the screw falling prevention member is a wire which abuts on or is located adjacent to a head portion of the screw member.

4. The falling prevention structure for a socket in an electric power tool according to claim 3, wherein the wire has a rectangular loop shape.

5. The falling prevention structure for a socket in an electric power tool according to claim 1, wherein
a cover is mounted on the housing of the electric power tool,
an attaching groove is provided along a circumference of a front end of the housing so that the cover is engaged with the attaching groove and is thus retained, and
the supporting member is mounted on the front end of the housing while being engaged with the attaching groove.

6. The falling prevention structure for a socket in an electric power tool according to claim 3, wherein the supporting member is a supporting ring which is partially split up and forms a pair of clamp pieces having a given space therebetween, and the supporting member is enabled to be mounted on the electric power tool by screwing the screw member into a nut, the screw member passing through one of the clamp pieces, and the nut being fitted into the other one of the clamp piece.

7. The falling prevention structure for a socket in an electric power tool according to claim 6, wherein a protrusion, to which the connecting body is connected, is provided on a front surface of the one clamp piece.

8. The falling prevention structure for a socket in an electric power tool according to claim 6, wherein one side of the wire is connected to one of the clamp pieces in a rotatable manner, and engageable recessed portions are provided in both front and rear surfaces of the other one of the clamp piece, respectively, so that the other side of the wire facing the one side thereof is elastically engaged with the engageable recessed portions at a position abutting on or adjacent to a head portion of the screw member.

9. The falling prevention structure for a socket in an electric power tool according to claim 1, wherein the connecting body includes a carabiner.

10. The falling prevention structure for a socket in an electric power tool according to claim 1, wherein the socket includes a socket portion to which a bolt or a nut is able to be fitted, and a bit portion having a same figure as a bit that is mounted on the output shaft.
